(19) United States
(12) Patent Application Publication
(10) Pub. No.: US 2007/0195158 A1
(43) Pub. Date: Aug. 23, 2007

(54) Apparatus and methods for managing video calls on a wireless device

(76) Inventor: Jonathan K. Kies, Encinitas, CA (US)

Correspondence Address: QUALCOMM INCORPORATED, 5775 MOREHOUSE DR., SAN DIEGO, CA, 92121, US

(21) Appl. No.: 11/361,220

(22) Filed: Feb. 23, 2006

(51) Int. Cl. H04N 7/14

(52) U.S. Cl. 348/14.01

(57) ABSTRACT

Apparatus, methods, computer readable media and processors operable on a wireless device may manage video calls on a wireless device. A video call management method may include a video call management application operable on the wireless device. The video call management application may be configured with a filtering parameter, which may be applied to a received video call to determine a manner of processing the video call. Based on the filtering, the video call may be processed in any number of predetermined and/or user-defined manners. Further, information relating to the incoming video call may be stored into a call log viewable by the user.

### BACKGROUND

The described embodiments generally relate to wireless communication devices and computer networks, and more particularly relate to apparatus and methods for managing video calls on a wireless device.

Wireless networking connects one or more wireless devices to other computer devices without a direct electrical connection, such as a copper wire or optical cable. Wireless devices communicate data, typically in the form of packets, across a wireless or partially wireless computer network and open a “data” or “communication” channel on the network such that the device can send and receive data packets. The wireless devices often have wireless device resources, such as programs and hardware components, which individually and cooperatively operate to use and generate data in accordance to their design and specific protocol or configuration.

Wireless devices are being manufactured with increased computing capabilities and input/output peripherals, and now include such features as video displays for real time as well as non-real time video services, as well as built-in cameras for two-way mobile video telephony, including such services as video teleconferencing. In some embodiments, these “smart” devices are based upon open mobile telephone standards.

In some cases, however, a wireless device user may not want to enter into a video teleconference. Further, because wireless services and features facilitate direct contact with a wireless device user, wireless devices have become targets for unauthorized, unsolicited, and in many cases, inappropriate calls. For example, common forms of wireless device contact may be delivered via voice services and/or text services. Similarly, video telephony offers new and fertile territory for originators of unauthorized, unsolicited, and/or inappropriate communications. And, due to the relatively public nature of a video teleconference on a wireless device, the user may require more restrictions on accepting such calls when compared with an audio call, which is relatively private.

As mobile video telephony becomes more common, the problem of managing video calls may require solutions previously not needed in the voice-only domain. For instance, users may send lewd or offensive video content live or streamed through standard video telephony applications.

Some currently available push-to-talk and instant messenger technologies include blacklist capabilities. However, most communication methods and apparatus do not have more sophisticated mechanisms for managing the receipt of communications, nor do they address the unique problem posed by video transmissions.

Accordingly, it would be advantageous to provide apparatus and methods that manage inappropriate video calls. Such apparatus and methods may allow a user of a wireless device to control the time and place for receiving a video call and may provide a mechanism for blacklisting and otherwise discouraging unwanted video calls.

### SUMMARY

The described embodiments comprise apparatus, methods, computer readable media and processors operable to manage the receipt and processing of video calls on a wireless device.

One aspect of a method for managing video calls on a wireless communications device may comprise receiving an incoming video call, filtering the video call based on a predetermined filtering parameter, and processing the incoming video call according to a predetermined video call processing option based on the filtering. In related aspects, a computer program may be resident in a computer readable medium that, when executed, directs a computer device to perform the above-stated actions. In other related aspects, at least one processor may be configured to perform the above-stated actions.

Another aspect includes an apparatus for managing video calls received by a wireless device. The apparatus comprises means for receiving an incoming video call, means for filtering the video call based on a predetermined filtering parameter, and means for processing the incoming video call according to a predetermined video call processing option based on a predetermined filtering parameter.

In yet another aspect, an apparatus for managing video calls comprises a computer platform having a communications module configured to receive a video call. The apparatus also comprises a video client disposed on the computer platform, where the video client is configured to receive the video call forwarded from the communications module. Further, the apparatus comprises a video call management client on the computer platform, where the video call management client has a filtering parameter and a corresponding video call processing option. Additionally, the video call management client further comprises logic operable to apply the filtering parameter to the video call and process the video call according to the video call processing option.

In yet other aspects, a method for managing video calls to a wireless device comprises receiving a request to transmit a video call management client to a wireless device, where the video call management client operable to take a predetermined action with a video call based on a predetermined filtering parameter. The method further comprises validating the request. Additionally, the method comprises transmitting the video call management client to the wireless device based on the validating. In related aspects, a computer program may be resident in a computer readable medium that, when executed, directs a computer device to perform the above-stated actions. In other related aspects, at least one processor may be configured to perform the above-stated actions

### BRIEF DESCRIPTION OF THE DRAWINGS

The disclosed embodiments will hereinafter be described in conjunction with the appended drawings provided to illustrate and not to limit the disclosed embodiments, wherein like designations denote like elements, and in which:

FIG. 1 illustrates an aspect of a system comprising a wireless device that includes a video call management client;

FIG. 2 illustrates an aspect of the wireless device of FIG. 1;

FIG. 3 illustrates an aspect of the video call management client of FIG. 1;

FIG. 4 illustrates an aspect of the application server of FIG. 1;

FIG. 5 illustrates an aspect of a cellular telephone system incorporating components of FIG. 1, and further comprising a location determination element; and

FIG. 6 is a flowchart of an aspect of a method of managing video calls, such as by utilizing the video call management client of FIG. 1.

### DETAILED DESCRIPTION

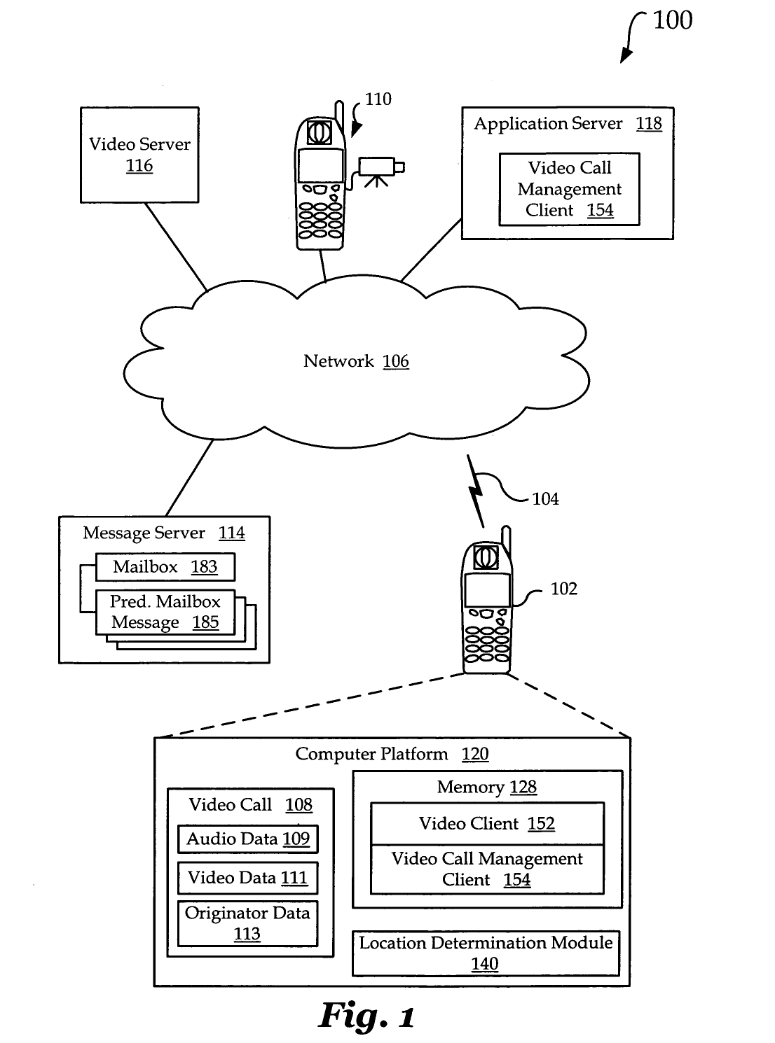

Referring to FIG. 1, a video call management system 100 comprises a wireless device 102 operable to initiate and receive a video call 108 with other video enabled devices connected to network 106. Video call 108 comprises a transmission of audio data 109 and video data 111, which represent a moving image and corresponding audio information captured by and transmitted from the respective device, and/or received by and re-processed into the original moving image and corresponding audio. Further, such other video enabled devices may include a video server 116 capable of, at least, transmitting non-real time video, and video device 110 capable of, at least, transmitting live video, and/or some combination of both. Additionally, a message server 114 may be provided to allow a user of wireless device 102 to forward and/or store a video call 108, which may occur automatically based upon predetermined parameters as will be discussed below. Network 106 includes an air interface 104 for interconnecting wireless device 102 and any other video enabled device, such as server 116 and device 110. System 100 may also include an application download server 118 operable to download a video call management client 154 to the wireless device 102.

Video call management client 154 may be configured to manage incoming video calls 108 based on predetermined filtering parameters, such as an originator of the video call, a time, and a wireless device location. Further, video call management client 154 may further include predetermined video call processing options, which may be correlated to the filtering parameters, which define how to handle a given video call. For example, predetermined video call processing options may include sending a video call to a mailbox, blocking video data while allowing audio data, blocking audio data while allowing video data, transmitting a predetermined response, and letting the video call be processed normally so as to establish a duplex video transmission. These aspects will be discussed below in more detail.

Wireless device 102 is configured for video telephony and may include any type of computerized device capable of receiving and/or transmitting video call 108. Wireless device 102 may include, but is not limited to, a cellular telephone, a personal digital assistant, a portable computer with a camera and microphone, and even a separate computer platform that has a wireless communications portal, and which also may have a wired connection to a network or the Internet. The wireless device may also be a remote-slave, or other device that does not have an end-user thereof, but simply communicates data across the wireless network 106, such as remote sensors, diagnostic tools, and data relays.

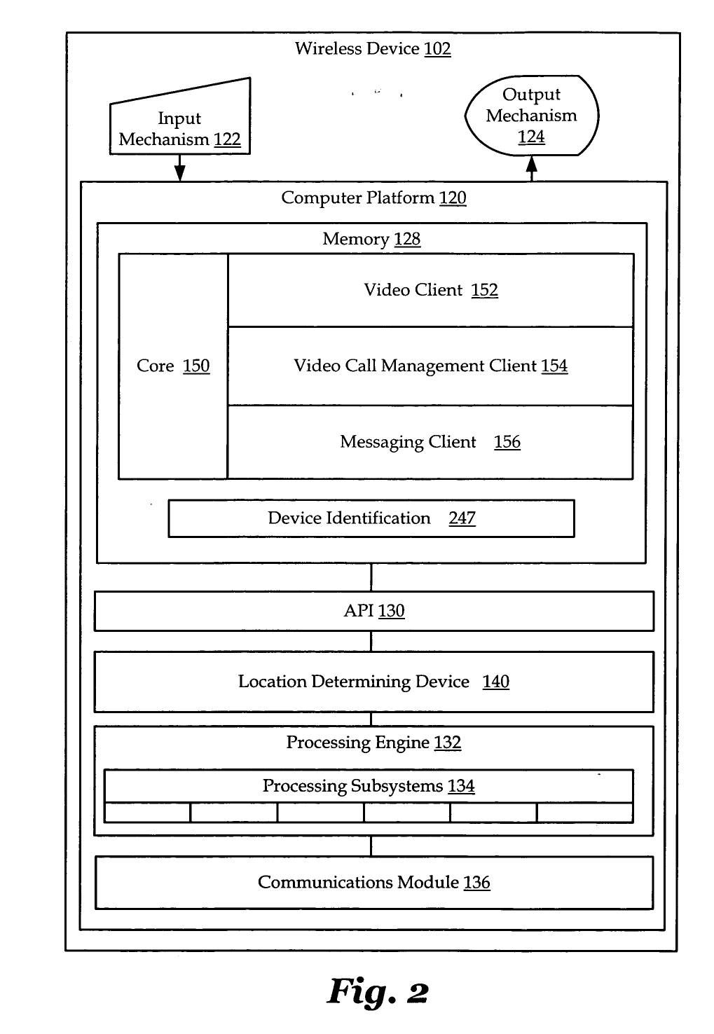

Referring to FIG. 2, wireless device 102 may comprise a computer platform 120 interconnected with an input mechanism 122 for receiving inputs from a user and an output mechanism 124 for presenting information to the user, where both mechanism may be capable of respectively receiving and presenting audio and video information. For example, input mechanism 122 may include, but is not limited to, a mechanism such as a microphone, a camera, a keyboard, a mouse, a touch-screen display and a voice recognition module. Output mechanism 124 may include, but is not limited to, an audio speaker, a display, and a haptic feedback mechanism.

Computer platform 120 may further include a communications module 136 embodied in hardware, content, software, and combinations thereof, operable to receive/transmit and otherwise enable communication between components within the wireless device 102, as well as to enable communications between the wireless device 102 and other devices on the network 106.

In addition, computer platform 120 may include a processing engine 132, which may be an application-specific integrated circuit (“ASIC”), or other chipset, processor, logic circuit, or other data processing device. Processing engine 132 is operable to execute an application programming interface (“API”) layer 130 that may interface with any resident programs.

In one non-limiting aspect, API 130 is a runtime environment executing on the respective mobile unit. One such runtime environment is Binary Runtime Environment for Wireless® (BREW®) software developed by Qualcomm, Inc., of San Diego, Calif. Other runtime environments may be utilized that, for example, operate to control the execution of applications on wireless computing devices.

Still referring to FIG. 2, processing engine 132 may include one or a combination of processing subsystems 134 which provide wireless device 102 with selected functional capabilities. In aspects of a cellular telephone, for example, processing subsystems 134 may include, but are not limited to: sound, non-volatile memory, clock, location determination, file system, transmit, receive, searcher, layer 1, layer 2, layer 3, main control, remote procedure, handset, power management, diagnostic, digital signal processor, vocoder, messaging, call manager, Bluetooth® system, Bluetooth® LPOS, position determination, position engine, user interface, sleep, data services, security, authentication, USIM/SIM, voice services, graphics, USB, multimedia such as MPEG, GPRS, etc.

Non-limiting, processing subsystems 134 may include any subsystem components, for example, a satellite receiver, that interact with applications executing on computer platform 120. For example, processing subsystems 134 may include any subsystem components that receive data reads and data writes from API 130 on behalf of the memory resident client applications.

Computer platform 120 may also include a memory 128, which may comprise volatile and nonvolatile memory such as read-only and/or random-access memory (RAM and ROM), EPROM, EEPROM, flash cards, or any memory common to computer platforms. Further, memory 128 may include one or more flash memory cells, or may comprise any secondary or tertiary storage device, such as magnetic media, optical media, tape, or soft or hard disk.

Memory 128 may be operable to store basic cellular telephony core applications 150 as well as more sophisticated user applications, including, but not limited to: at least one video client 152; a video call management client 154; and a messaging client 156, such as a short message service (“SMS”) and a multimedia messaging system (“MMS”).

Video client 152 may include any client application capable of transmitting and/or receiving a video call, for example, non-real time and/or real time services including video teleconferencing. In particular, video client 152 may be operable to capture and audio data 109 and video data 111, such as by recording an image with a camera and recording a sound with a microphone, and/or to receive video call 108 and process audio data 109 and video data 111, such as by presenting a video image on a display and presenting sound via a speaker.

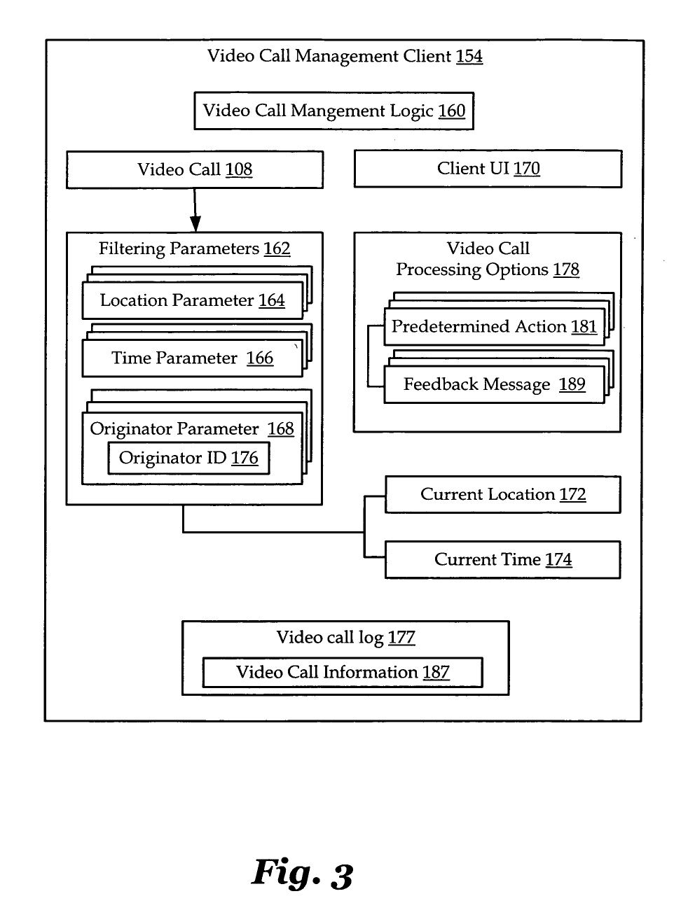

FIG. 3 is a block diagram of the video call management client 154, which in some embodiments is controlled by video call management logic 160 operable to intercept and automatically manage/direct a video call 108 (FIG. 1) received by the communications module 136 (FIG. 2) that, in the absence of video call management client 154, would be presented to the video client 152 and output to the user via output mechanism 124 (FIG. 2). The video call management client 154 may also be configured to allow a user to manually manage/direct incoming video calls 108.

The video call management client 154 may be installed on the wireless device 102, for example, at the time of manufacture, downloaded from application download server 118, and may be installed from a connected computer device.

A client user interface (“UI”) 170 may allow a user to configure one or more filtering parameters 162 with a corresponding one of one or more video call processing options 178 used by the video call management logic 160 to automatically direct video calls without user intervention, and in some cases without user notification. Client UI 170 may also be operable to permit on-the-fly rejection of a video call, for example, by a keystroke on a keypad or other user initiated action on input mechanism 122. Filtering parameters 162 and call processing options 178 may be configurable, such as by a user of the wireless device, a provider of the wireless device, a provider of the wireless network service, and/or a provider of video call management client.

At least one filtering parameter 162, in combination with at least one call processing option 178, may respectively include any predetermined parameter associated with a given incoming video call 108 and a corresponding predetermined option that directs or indicates how to handle the video call. For example, filtering parameters 162 may include, but are not limited to, one or more of each of a predetermined location parameter 164 comprising a given geographic position, a predetermined time parameter 166 comprising a time, a range of times and/or a date, and a predetermined video call originator parameter 168 comprising an originator identification (ID) 176.

Similarly, for example, call processing options 178 include one or more predetermined actions 181, including but not limited to:
an “accept video call” action which comprises allowing the given incoming video call 108 to be processed in a manner that causes wireless device 102 to generate a notifying output, such as a audible sound, a visible light, and/or a haptic feedback intended to notify the user of the presence of the given incoming video call, and upon a user “answering” the video call, the establishment of a duplex video transmission that presents both audio data 109 and video data 111 associated with the given video call 108;
an “accept—audio only” action that allows the user to be notified of the incoming video call, but upon answering of the call only presents audio data 109 (FIG. 1) associated with the call;
an “accept—video only” action that allows the user to be notified of the incoming video call, but upon answering of the call only presents video data 111 (FIG. 1) associated with the call;
a “reject—forward to mailbox” action that automatically forwards the given incoming video call 108 to a voice and/or video mailbox having one of a plurality of predetermined mailbox messages. Mailbox 183 (FIG. 1) and mailbox message 185 may be located at a remote location across wireless network 106, such as at message server 114 (FIG. 1). Mailbox 183 and mailbox message 185 may also reside locally on wireless device 102. Furthermore, predetermined mailbox message 185 may be selected from a plurality of predetermined audio and/or video messages that may include a standard message and one or more additional messages. A message identifier associated with each message may allow a specific message to be selected by a selected processing option, of processing options 178, and/or corresponding filter parameter 162;
a “reject—notify user” action which provides the action described above with regard to the “reject—forward to mailbox” action, but further includes notifying the user of wireless device 102 of the given incoming call 108, such as by generating the notifying output described above with regard to the “accept video call” action 181, and/or by storing relevant video call information 187 in a rejected video call log 177, and, in this case, there may be a predetermined delay associated with the rejection of the given incoming video call to enable the user to become aware of the notifying output and to give the user the option of manually overriding this option and accepting the video call;
a “reject—send feedback” action which may either automatically respond to the incoming video call 108 by sending to the originator a predetermined one of a plurality of predetermined feedback messages 189, such as a predetermined text, audio and/or video message which may be selected from a plurality of predetermined audio, video and/or text messages and which may include a standard message and one or more additional messages that may be selected, for example, based on the corresponding filter parameter 162; and
a “block” action which presents a busy signal indicator to the originator who is attempting to establish the video call.

One or more filtering parameters 162 may be stored on wireless device 102 and referenced to a corresponding video call processing option 178 in order to establish video call management procedures.

For example, location parameter 164 may be entered into wireless device 102, for example by the user of wireless device 102, and allows the video call management client 154 to accept or reject an incoming video call 108 based upon a comparison of the given location parameter 164 with a current geographic location 172 of wireless device 102. For example, video call management client 154 may retrieve current geographic location 172 from computer platform 120, such as processing subsystem 134 and/or memory 128, from wireless network 106, and/or from a remotely based location determination entity, as will be discussed below. Current geographic location 172 may be updated in any manner, including, but not limited to, updating automatically at predetermined intervals, updating based on a predetermined event such as establishing a communications channel, updating upon receiving a call, and updating based on receiving an input from the user of wireless device 102.

The current geographic location 172 may be determined by operation of a location determination module 140 (FIG. 1) resident on wireless device 102. Location determination module 140 may include at least one of a hardware device, a software application, executable instructions, firmware, data and any combination thereof embodied within and/or operable by computer platform 120. Further, location determination module 140 includes, but is not limited to, various position determination systems, such as satellite-based systems, network-based systems, and combinations thereof. For example, location determination module 140 may comprise systems such as: a Global Positioning System (GPS); Assisted GPS (A-GPS) systems including the QPoint™ Positioning Software and gpsOne® hybrid Assisted GPS wireless location technology available from Qualcomm, Inc., San Diego, Calif.; and Localization Based Systems (LBS) such as Cell-ID, Enhanced Observed Time Difference (E-OTD), and Observed Timed Difference of Arrival (OTDOA). In some embodiments, location information may be received over an open communication connection 104 between wireless device 102 and the wireless network 106, in some cases “piggybacking” on an ongoing voice or data call across an open connection.

The user may enter coordinates, such as via the input mechanism 122, to manually set one or more location parameters 164, and/or may enter the coordinates defined by the current geographic location 172. In addition, location parameter 164 may also comprise a short text phrase, whereby the user may attach a descriptive label, i.e. “OFFICE”, such as via input mechanism 122, to the location parameter 164. Location parameters 164 may be stored in a table for future use, thereby providing a user-friendly menu for building a set of location parameters 164.

For example, through use of video call management logic 160, as user may set location parameter 164 and the associated call processing option 178 as follows: the user may enter a given geographic location and automatically determine the corresponding coordinates though execution of location determination module 140; the logic 160 may then allow the user to name this location, and enter this location as a location parameter 164; further, logic 160 may allow the user to then select a predetermined processing option 178, or create a new processing option, and associate the given option with the given location. In some aspects, the user may enter a distance, such as the length of a radius, to associate an area, such as a circle, with a given location so that any video call received within the given area is handled according to the predetermined video call processing option 178.

Further, for example, in some embodiments, one or more time parameters 166 identify one or more predetermined times and/or one or more predetermined range of times, and thereby allows the user to accept or reject an incoming video call 108 received at a given current time 174 based on the time parameter 166. For example, the video call management logic 160 may compare the time parameter 166 with an updatable current time 174 to determine whether to reject or allow the video call. The client UI 170 may allow a user to enter the time parameter 166 in various formats including, but not limited to, “FROM-TO” format, as well as a menu system featuring selectable portions of a 24-hour time period, as well as day-specific entries, e.g. where different time parameters may be entered on weekdays as opposed to weekends, where different times may be entered on holidays, etc.

Furthermore, a user may capture originator data 113 from manually blocked video calls, or from answered video calls, to configure a new originator parameter 168 entry to the filtering parameters 162. An entry to the input mechanism 122 may quickly allow for management of future video calls from a predetermined video call originator. In other alternatives, some originator parameters 168 may be automatically linked with some predetermined video call processing options 178. For example, a user may configure video call management client 154 to automatically link originator data 113 found in a “Contacts” list or in a “Phonebook” with an “accept” video call action.

In some embodiments, the originator parameter 168 may allow a user to accept or reject an incoming video call 108 based on a match between originator data 113 associated with the incoming video call and a predetermined originator ID 176. For example, originator parameter 168 may comprise one or more originator IDs 176 associated with a predetermined action 181, such as the “block” video call action to prohibit receiving calls from predefined parties, or the “accept” video call action to allow calls from predefined parties. Further, it should be noted that originator parameter 168 may be configured to “accept” video calls from all but those predefined originator ID's associated with the “block” action, or to “block” calls from all but those predefined originator ID's associated with the “accept” action. Further, the format of the originator parameter 168 may be flexible to accommodate any video originator address format defined by originator data 113, including, but not limited to, a URL, a telephone number, a MAC address, and an E-mail address of the video call initiator. The video call management logic 160 may parse and validate the entry to determine the type of machine and process the entry accordingly. Additionally, in some aspects the originator parameter 168 may operate in conjunction with the location parameter 164 and the time parameter 166 to allow a fully configurable video call management capability.

Video call management options 178 may provide a user with any number of predetermined and/or user defined functional responses to an incoming video call 108.

As noted above, video call management logic 160 may be operable to enter video call information 187 relating to rejected video calls into call log 177 for later viewing by the user. The call log 177 may be manipulated by operation of the input mechanism 122 (FIG. 2) under control of the client UI 170 and log entries may be cleared by an appropriate keystroke or other user action. Further, in a similar manner, the user may update filtering parameters 162 through a disposition of an entry in call log 177. For example, in one aspect, the user may add a given originator ID from a rejected video call into a given originator parameter 168 and associate the given originator ID with an “accept” video call action.

In addition, all user configurable filtering parameters 162 and video call management options 178 may be cleared en banc or selectively removed by operation of the client UI 170. Furthermore, the video call management client 154 may be updated on-line to accommodate new formats and features, and/or to change any parameters/settings.

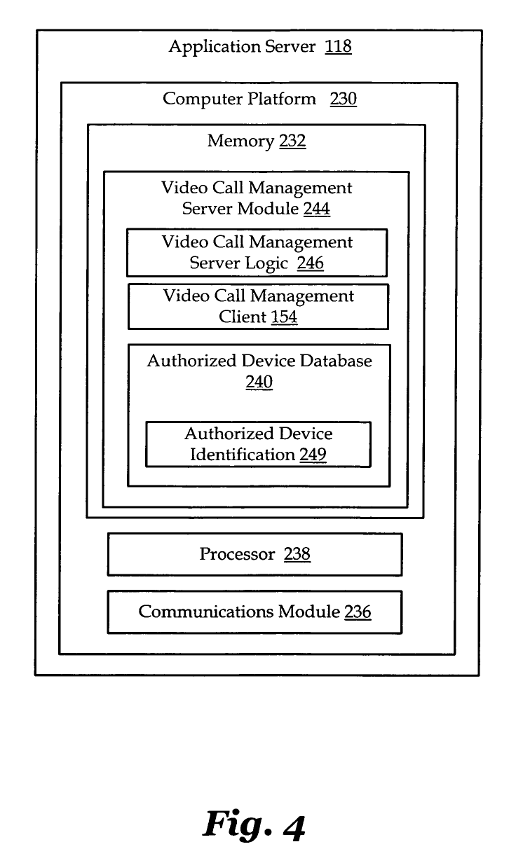

Referring to FIGS. 1 and 4, application download server 118 may, under control of video call management server logic 246, operate to download the video call management client 154, or updates thereto, to the wireless device 102 via network 106. The application download server 118 may comprise a computer platform 230, a memory 232, a processor 238, and a communications module 236. The memory 232 may further comprise a video call management server module 244 including the video call management server logic 246 and the latest version of the video call management client 154 or updates thereto. Video call management server module 244 may include one or a combination of hardware, software, firmware, executable instructions and data operable to perform the functionality described herein. Further, video call management server module 244 may be operable to automatically update the video call management client 154.

Furthermore, the video call management server logic 246 may validate a request for download prior to initiating the download. For example, a database of authorized devices 240 may be referenced, and a device identification 247 (FIG. 2) associated with wireless device 102 may be compared to an authorized device identification 249 in database 240 to prevent unauthorized downloads of the video call management client 154 to unauthorized devices.

In addition, application download server 118 may further comprise at least one of any type of server, personal computer, mini computer, mainframe computer, or any computing device either special purpose or general computing device operable to receive a request from the wireless device 102 to download components of the video call management client 154.

Network 106 includes any communications network operable, at least in part, for enabling wireless communications between wireless device 102 and any other device connected to network 106. Further, network 106 may include all network components and all connected devices that form the network. For example, network 106 may include at least one, or any combination, of: a cellular telephone network; a terrestrial telephone network; a multicast network such as a Forward Link Only (FLO) network; a digital video broadcasting (DVB) network, such as DVB-S for satellite, DVB-C for cable, DVB-T for terrestrial television, DVB-H for terrestrial television for handhelds; a terrestrial telephone network; a satellite telephone network; an infrared network such as an Infrared Data Association (“IrDA”)-based network; a short-range wireless network; a Bluetooth® technology network; a ZigBee® protocol network; an ultra wide band (“UWB”) protocol network; a home radio frequency (“HomeRF”) network; a shared wireless access protocol (“SWAP”) network; a signaling system 7 (“SS7”) network; a wideband network, such as a wireless Ethernet compatibility alliance (“WECA”) network, a wireless fidelity alliance (“Wi-Fi Alliance”) network, and a 802.11 network; a public switched telephone network; a public heterogeneous communications network, such as the Internet; a private communications network; and land mobile radio network.

Suitable examples of telephone networks include at least one, or any combination, of analog and digital networks/technologies, such as: code division multiple access (“CDMA”), wideband code division multiple access (“WCDMA”), universal mobile telecommunications system (“UMTS”), advanced mobile phone service (“AMPS”), time division multiple access (“TDMA”), frequency division multiple access (“FDMA”), orthogonal frequency division multiple access (“OFDMA”), global system for mobile communications (“GSM”), single carrier,(“1X”) radio transmission technology (“RTT”), evolution data only (“EV-DO”) technology, general packet radio service (“GPRS”), enhanced data GSM environment (“EDGE”), high speed downlink data packet access (“HSPDA”), analog and digital satellite systems, and any other technologies/protocols that may be used in at least one of a wireless communications network and a data communications network.

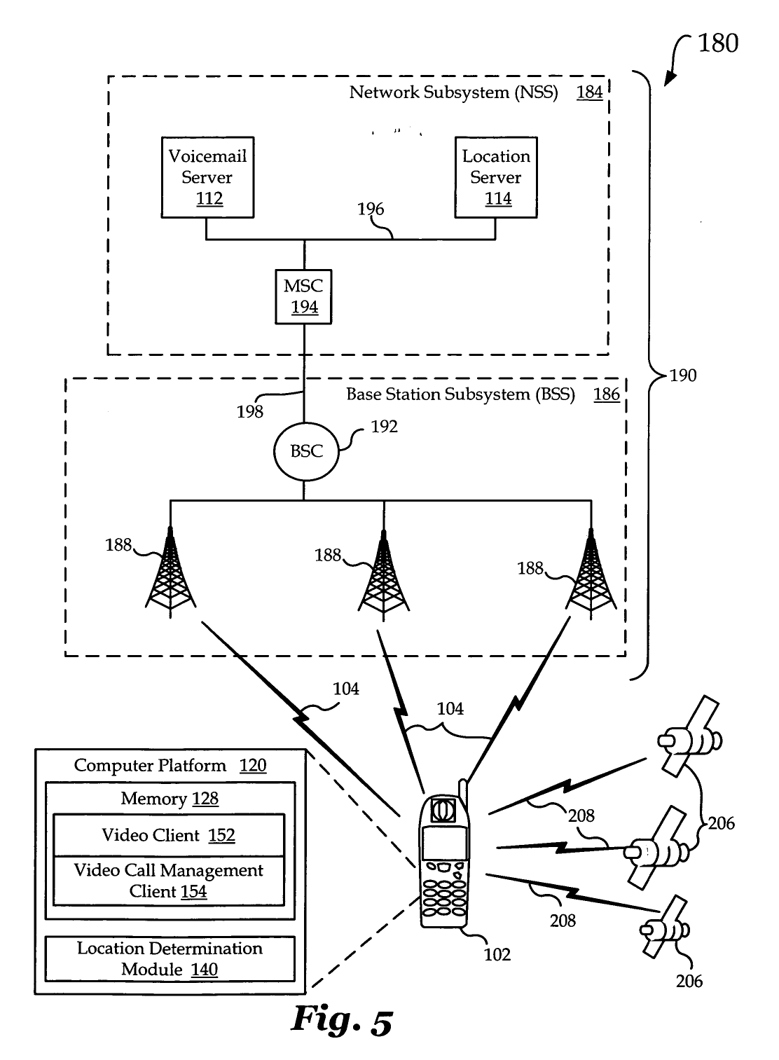

FIG. 5 illustrates one aspect of a non-limiting cellular telephone system 180 and comprises at least one wireless device 102 and a mobile telephone system 190. The mobile telephone system 190 may comprise a base station subsystem (“BSS”) 186 connected to a network subsystem (“NSS”) 184. BSS 186 may further comprise multiple base transceiver stations (“BTS”) 188 connected to a base station controller (“BSC”) 192. An interface 198 may be implemented between multiple BSS's 192 and a mobile switching center (“MSC”) 194. Application servers, including voicemail servers 112 and location based servers 114, may be connected to the MSC 194 via another network 196. A location based server 114 may be used to deploy services that enable users on network devices to find other people, vehicles, resources, services or other network devices. Location based servers also enable others to find users, as well as enabling users to identify their own location.

BTS 188 ultimately broadcasts messages, such as, handover, authentication, authorization, location update, etc., wirelessly to wireless device 102 via an air interface 104, such as short messaging service (“SMS”), multimedia messaging system (“MMS”), and other over-the-air methods.

A request for the location of a mobile unit may be generated either by a remote device, i.e. rescue or medical personnel, or locally on the mobile unit itself. A locally generated location request may be a user or application initiated request.

Location determination methods may include standalone and assisted modes, and include such technologies as QPoint™ Positioning Software and gpsOne® position-location technology available from Qualcomm, Inc., San Diego, Calif., Cell-ID, Enhanced Observed Time Difference (E-OTD), Observed Timed Difference of Arrival (OTDOA), wireless assisted GPS (“A-GPS”). In both standalone GPS and A-GPS, positioning information is gathered from a satellite system 206.

By accurately measuring the distance from at least three satellites 206, a location determination module 140, such as a GPS, receiver, may triangulate its position anywhere on earth and calculates distance by measuring the time required for a signal 208 to travel from the satellite 206 to the receiver 140.

In standalone mode, the positioning data may be sent directly to the wireless device 102 without any assistance data from the network 186. Alternatively, a satellite assisted solution may have the wireless device 102 combine satellite information, received by the wireless device 102, with ranging measurements taken from the multiple BTS's 188. This combined information may be sent to a location server 114, such as an A-GPS location server (“A-GPS LS”). The location server 114 may then determine the exact coordinates of the wireless device 102 and send them back to the wireless device 102. Furthermore, the location server 114 may use information sent by the wireless device 102 to inform the wireless device 102 as to which satellites 206 it should listen to gather positioning information.

Cellular telephone system 180 is merely exemplary and may include any system whereby remote modules, such as mobile units 102 communicate packets including voice and data over-the-air between and among each other and/or between and among components of a mobile communications network, including, without limitation, wireless network carriers and/or servers.

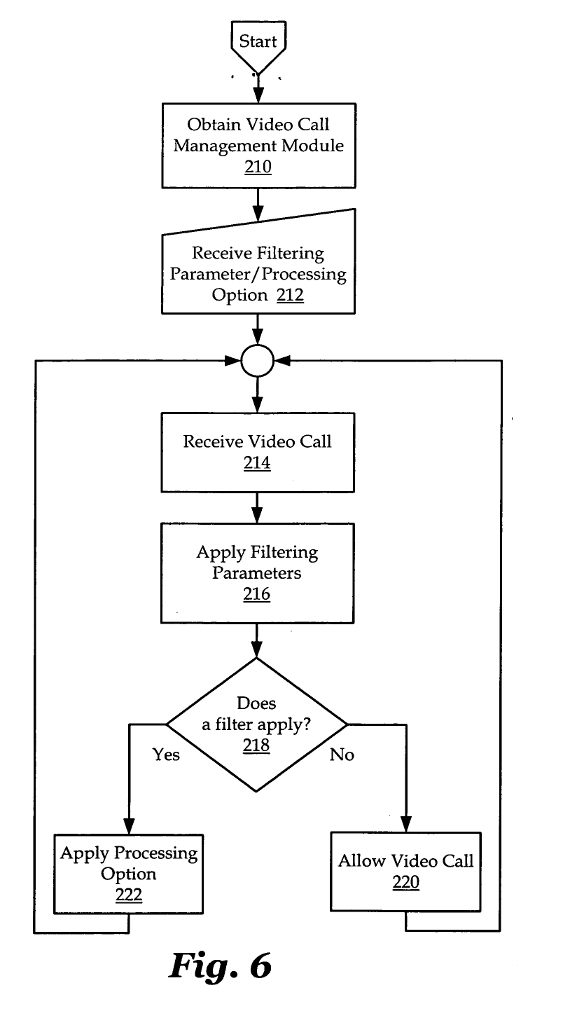

FIG. 6 is a flowchart of one aspect of the video call management client 154 (FIG. 3) according to system 100. At step 210, the method may include obtaining a video call management module. For example, in some aspects, video call management client 154 may be loaded into the memory of the wireless device 102. As disclosed, the video call management client 154 may be downloaded over the network 106. At step 212, the method may include receiving a filtering parameter and corresponding video call processing option. For example, a user may configure the video call management client 154 by appropriate setting of the filtering parameters 162 (FIG. 3) and the corresponding video call processing options 178 (FIG. 3). As discussed above, other entities, such as a network service provider and/or an application provider may configure all and/or parts of video client 152.

At step 214, the method may further include receiving a video call. For example, in some aspects, a video call may be received by the communications module 136 of wireless device 102 (FIG. 2). Additionally, for example, this portion of the method may include intercepting the video call 108 (FIG. 1) before the video client 152 (FIG. 1) is apprised of the incoming video call.

At step 216, the method may include applying a filtering parameter to the received video call. For example, in some aspects, one or more of the current geographic location 172 (FIG. 3), the current time 174 (FIG. 3), and the originator data 113 (FIG. 1) associated with the received video call may be filtered/matched against one or more of the respective location parameter 164 (FIG. 4), the time parameter 166 (FIG. 166), and the originator-based parameter 168 (FIG. 3).

At step 218, the method may further include a determination of whether or not the filtering parameter applies to the received video call. For example, this portion of the method determines whether or not any matches exist between any filtering parameter and any characteristic associated with the received video call.

At step 220, the method may include allowing the video call if no filtering parameters apply. For example, based upon the results of step 216, a decision is then made as to whether or not a predetermined video call processing option 178 (FIG. 3) should be executed. If no filtering parameter applies to the incoming video call, then the video call is forwarded to the video client 152 (FIG. 1).

At step 222, the method may further include applying a processing option if a filtering parameter applies to the received video call. For example, in some aspects, if the filtering produces a match, then the video call 108 (FIG. 1) is processed according to the configured video call processing option 178 (FIG. 3). Additionally, processing may include logging information regarding the call in a call log 177 (FIG. 3) viewable by the user. As noted above, processing options 178 may be user selected or pre-defined by another entity, may be menu driven, and may include the predetermined actions 181 (FIG. 3) discussed above. Furthermore, an audible/visual indication may be generated to notify the user of the wireless device 102 of a filtered video call and provide the option to view the call log 177.

Thus, the video call management client 154 is fully configurable, and allows a user to set different processing options 178 for video calls filtered based on different filtering parameters 162.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor, logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

While the foregoing disclosure shows illustrative aspects and/or embodiments, it should be noted that various changes and modifications could be made herein without departing from the scope of the described aspects and/or embodiments as defined by the appended claims. Furthermore, although elements of the described embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for managing video calls on a wireless communications device, comprising:
receiving an incoming video call;
filtering the video call based on a predetermined filtering parameter; and
processing the incoming video call according to a predetermined video call processing option based on the filtering.

2. The method of claim 1, wherein filtering the video call further comprises:
determining a current time; and
determining if the current time falls within a predetermined time parameter.

3. The method of claim 2, wherein at least one of the current time and the predetermined time parameter comprise at least one of a minute, an hour, a day, a month and a year.

4. The method of claim 1, wherein filtering the video call further comprises:
determining a current geographic location; and
determining if the current geographic location falls within a predetermined location parameter.

5. The method of claim 1, wherein filtering the video call further comprises:
determining originator data corresponding to an originator of the video call; and
determining if the originator data matches a predetermined originator identification.

6. The method of claim 1, wherein processing the video call further comprises at least one of generating only audio data associated with the video call, generating only video data associated with the video call, and sending a predetermined feedback message in response to the video call.

7. The method of claim 1, wherein processing the video call further comprises at least one of accepting the video call, rejecting the video call with notice to a user of the wireless device of the video call, and blocking the video call.

8. The method of claim 1, wherein processing the video call further comprises forwarding the video call to a mailbox operable to generate a selected one of a plurality of predetermined mailbox messages.

9. The method of claim 8, wherein filtering the video call further comprises filtering based on at least one filtering parameter selected from the group of a location parameter, a time parameter and an originator parameter, and wherein the selected one of the plurality of predetermined mailbox messages is based on at least one of the filtering parameter and the predetermined video call processing option.

10. The method of claim 1, further comprising storing video call information associated with the video call.

11. The method of claim 1, wherein processing the incoming video call comprises transmitting a message operable to forward an originator of the incoming video call to a predetermined destination.

12. A computer readable medium tangibly storing a sequence of instructions that, when executed, causes a computer device to perform the actions of:
receiving an incoming video call;
filtering the video call based on a predetermined filtering parameter; and
processing the incoming video call according to a predetermined video call processing option based on a predetermined filtering parameter.

13. At least one processor configured to perform the actions of:
receiving an incoming video call;
filtering the video call based on a predetermined filtering parameter; and
processing the incoming video call according to a predetermined video call processing option based on a predetermined filtering parameter.

14. An apparatus for managing video calls received by a wireless device, comprising:
means for receiving an incoming video call;
means for filtering the video call based on a predetermined filtering parameter; and
means for processing the incoming video call according to a predetermined video call processing option based on a predetermined filtering parameter.

15. An apparatus for managing video calls, comprising:
a computer platform;
a communications module disposed on the computer platform, the communications module configured to receive a video call
a video client disposed on the computer platform, the video client configured to receive the video call forwarded from the communications module;
a video call management client on the computer platform, the video call management client having a filtering parameter and a corresponding video call processing option, wherein the video call management client further comprises logic operable to apply the filtering parameter to the video call and process the video call according to the video call processing option.

16. The apparatus of claim 15, further comprising a current time stored on the computer platform, wherein the filtering parameter further comprises a predetermined time parameter, and wherein the logic is further operable to compare the current time with the predetermined time parameter and execute the video call processing option based on the comparison.

17. The apparatus of claim 16, wherein at least one of the current time and the predetermined time parameter comprise at least one of a minute, an hour, a day, a month and a year.

18. The apparatus of claim 15, further comprising a location determination module disposed on the computer platform, the location determination module having a current geographic location, wherein the filtering parameter further comprises a predetermined location parameter, and wherein the logic is further operable to compare the current geographic location with the predetermined location parameter and execute the video call processing option based on the comparison.

19. The apparatus of claim 15, wherein the video call further comprises originator data corresponding to an originator of the video call, wherein the filtering parameter further comprises a predetermined originator identification, and wherein the logic is further operable to compare the originator data with the predetermined originator identification and execute the video call processing option based on the comparison.

20. The apparatus of claim 15, wherein the video call processing option further comprises at least one of generating only audio data associated with the video call, generating only video data associated with the video call, and sending a predetermined feedback message in response to the video call.

21. The apparatus of claim 15, wherein the video call processing option further comprises at least one of accepting the video call, rejecting the video call with notice to a user of the wireless device of the video call, and blocking the video call.

22. The apparatus of claim 15, wherein the video call processing option further comprises forwarding the video call to a mailbox operable to generate a selected one of a plurality of predetermined mailbox messages.

23. The apparatus of claim 15, wherein the filtering parameter further comprises at least one of a location parameter, a time parameter and an originator parameter, and wherein the selected one of the plurality of predetermined mailbox messages is based on at least one of the filtering parameter and the predetermined video call processing option.

24. The apparatus of claim 15, further comprising a memory disposed on the computer platform and having video call information associated with the video call.

25. The apparatus of claim 15, wherein the apparatus comprises a wireless device having a communications module operable to receive the video call from a wireless network.

26. The apparatus of claim 25, wherein the wireless device comprises a cellular telephone, and wherein the wireless network comprises a cellular telephone network.

27. A method for managing video calls to a wireless device, comprising:
receiving a request to transmit a video call management client to a wireless device, the video call management client operable to take a predetermined action with a video call based on a predetermined filtering parameter;
validating the request; and
transmitting the video call management client to the wireless device based on the validating.

28. The method of claim 27, wherein the predetermined action comprises at least one of generating only audio data associated with the video call, generating only video data associated with the video call, and sending a predetermined feedback message in response to the video call.

29. The method of claim 27, wherein the predetermined filtering parameter comprises at least one of a location parameter and a time parameter.

30. The method of claim 27, wherein receiving the request further comprises receiving a device identification, and wherein validating the request further comprises authorizing the request based on a comparison of the device identification with an authorized device identification.

31. A computer readable medium tangibly storing a sequence of instructions that, when executed, causes a computer device to perform the actions of:
receiving a request to transmit a video call management client to a wireless device, the video call management client operable to take a predetermined action with a video call based on a predetermined filtering parameter;
validating the request; and
transmitting the video call management client to the wireless device.

32. At least one processor configured to perform the actions of:
receiving a request to transmit a video call management client to a wireless device, the video call management client operable to take a predetermined action with a video call based on a predetermined filtering parameter;
validating the request; and
transmitting the video call management client to the wireless device.

33. An apparatus for managing video calls to a wireless device, comprising:
means for receiving a request to transmit a video call management client to a wireless device, the video call management client operable to take a predetermined action with a video call based on a predetermined filtering parameter;
means for validating the request; and
means for transmitting the video call management client to the wireless device.

34. An apparatus for managing inappropriate video calls to a wireless device, comprising a computer platform, the computer platform including:
a communications module operable to receive a request from the wireless device, the request comprising a device identification associated with the wireless device;
an authorized device database comprising an authorized device identification; and
a video call management server module having video call management server logic and a video call management client, wherein the video call management server logic is operable, based on the request, to determine a match between the device identification and the authorized device identification and transmit the video call management client to the wireless device.
